(19) United States
(12) Patent Application Publication
(10) Pub. No.: US 2006/0050115 A1
(43) Pub. Date: Mar. 9, 2006

(54) Process for dyeing or printing textile fibre materials with gloss pigments

(76) Inventors: Patrice Bujard, Reinach (CH); Ulrich Strahm, Aesch (CH); Alex Kanzig, Therwil (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/530,616

(22) PCT Filed: Oct. 9, 2003
(86) PCT No.: PCT/EP03/11188

§ 371 Date: Apr. 7, 2005

(30) Foreign Application Priority Data
Oct. 17, 2002 (EP) 02405889.3

(51) Int. Cl. G01D 11/00

(52) U.S. Cl. 347/100

(57) ABSTRACT

The present invention relates to a process for dyeing or printing textile fibre materials, wherein a gloss pigment A or B is used comprising A(a) a core consisting of a substantially transparent or metallically reflecting material and A(b) at least one coating substantially consisting of one or more silicon oxides wherein the molar ratio of oxygen to silicon is on average from 0.03 to 0.95, or B(a) a core substantially consisting of one or more silicon oxides wherein the molar ratio of oxygen to silicon is on average from 0.03 to 0.95.

The present invention relates to a process for dyeing or printing fibre material with coloured gloss pigments by the pigment dyeing or pigment printing process.

Gloss pigments are effect pigments, that is to say reflecting flat particles whose radiation reflection is of different brightness and/or has a different reflection spectrum depending on the angle to the flat surface. In a surface coated using effect pigments, for example, the effect pigment particles tend to be oriented, within the surface coating, substantially parallel to the surface with the result that the coloured surface of the coating, when illuminated from a fixed white light source, is capable of exhibiting different colours depending on the viewing angle and the nature of the effect pigment.

A very large proportion of the light incident on an effect pigment is reflected but a relatively small portion thereof is absorbed. Applying thin layers to the flat pigment core gives rise to interference phenomena, the intensity and spectrum of the reflected ray varying according to the angle of incidence and the viewing angle.

The present invention relates to a process for dyeing or printing textile fibre materials, wherein a gloss pigment A or B is used comprising
A(a) a core consisting of a substantially transparent or metallically reflecting material and
A(b) at least one coating substantially consisting of one or more silicon oxides wherein the molar ratio of oxygen to silicon is on average from 0.03 to 0.95, or
B(a) a core substantially consisting of one or more silicon oxides wherein the molar ratio of oxygen to silicon is on average from 0.03 to 0.95.

The gloss pigments A or B used according to the invention are in general particles having a length of from 2 μm to 5 mm, a width of from 2 μm to 2 mm and a thickness of from 20 nm to 1.5 μm, and a length to thickness ratio of at least 2:1, the particles having a core with two substantially parallel faces, the distance between which faces is the shortest axis of the core.

In the case of the gloss pigments A, the core consists of a substantially transparent or metallically reflecting material having, applied to the parallel faces thereof, an SiOₓ layer wherein 0.03≦x≦0.95 and optionally further layers.

In the case of the gloss pigments B, the core is composed of SiOₓ wherein 0.03≦x≦0.95, optionally having one or more further layers applied to the parallel faces thereof.

The further layers may cover the parallel faces or the entire surface.

The gloss pigment A used according to the invention preferably has the following layer structure:

When the core A(a) consists of a metallically reflecting material, that material is preferably selected from Ag, Al, Au, Cu, Cr, Ge, Mo, Ni, Si, Ti, Zn, alloys thereof, graphite, Fe₂O₃ and MoS₂. Special preference is given to Al.

When the core A(a) consists of a transparent material, the material is preferably selected from mica, SiO_{y} wherein y is from 0.95 to 1.8, SiO₂ or SiO₂/TiO₂ mixtures. Special preference is given to SiO_{y} or silicon dioxide.

The material of the coating A(d) is advantageously a metal oxide, such as, for example, TiO₂, ZrO₂, SiO, SiO₂, SnO₂, GeO₂, ZnO, Al₂O₃, V₂O₅, Fe₂O₃, Cr₂O₃, PbTiO₃ or CuO, or a mixture thereof.

In a preferred embodiment, the gloss pigment A used according to the invention has the following layer structure: SiO₂/SiOₓ/SiO_{y}/SiOₓ/SiO₂, SiO₂/SiOₓ/SiO₂/SiOₓ/SiO₂, SiO₂/SiOₓ/Al/SiOₓ/SiO₂, TiO₂/SiO₂/SiOₓ/SiO₂/SiOₓ/SiO₂/TiO₂ or TiO₂/SiO₂/SiOₓ/Al/SiOₓ/SiO₂/TiO₂, wherein x is from 0.03 to 0.95 and y is from 0.95 to 1.8.

The core A(a) is a platelet having an average diameter of from 1 to 50 μm and a thickness of from 20 to 500 nm.

The thickness of the SiOₓ layer A(b) is generally from 5 to 200 nm, preferably from 5 to 100 nm.

The thickness of the SiO₂ layer A(c) is generally from 1 to 200 nm, preferably from 2 to 100 nm.

The thickness of the TiO₂ layer A(d) is generally from 1 to 200 nm, preferably from 10 to 150 nm.

Preferably, the SiOₓ, SiO₂ and TiO₂ layers arranged mirror-symmetrically with respect to the core of Al, SiO_{y} or SiO₂ each have the same layer thickness. In a further embodiment, the support layer may be surrounded on both sides by metal oxides having different layer thicknesses.

Especially preferably, the gloss pigment A used according to the invention has the following layer structure: SiO₂/SiOₓ/SiO_{y}/SiOₓ/SiO₂, SiO₂/SiOₓ/SiO₂/SiOₓ/SiO₂ or TiO₂/SiO₂/SiOₓ/SiO₂/SiOₓ/SiO₂/TiO₂, wherein x is from 0.03 to 0.95, preferably from 0.05 to 0.5, and y is from 0.95 to 1.8, preferably from 1.1 to 1.5, the core is a platelet having an average diameter of from 1 to 50 μm and a thickness of from 20 to 500 nm, the thickness of the SiOₓ layer is from 5 to 200 nm, preferably from 5 to 100 nm, the thickness of the SiO_{y} or SiO₂ layer is from 1 to 200 nm, preferably from 2 to 100 nm, and the thickness of the TiO₂ layer is from 1 to 180 nm, preferably from 50 to 160 nm.

The platelet-shaped or plane-parallel gloss pigments A having a core A(a) of SiO_{y} wherein 0.95≦y≦1.8, preferably wherein 1.1≦y≦1.5, are obtained by means of a process comprising the following steps:
i) vapour-deposition of a separating agent onto a (movable) carrier to produce a separating agent layer,
ii) vapour-deposition of an SiOₓ layer (0.03≦x≦0.95) onto the separating agent layer,
iii) vapour-deposition of an SiO_{y} layer (0.95≦y≦1.8) onto the SiOₓ layer obtained in step ii),
iv) vapour-deposition of an SiOₓ layer (0.03≦x≦0.95) onto the SiO_{y} layer obtained in step iii),
v) dissolution of the separating agent layer in a solvent,
vi) separation of the gloss pigment from the solvent,
   the SiO_{y} layer in step iii) being vapour-deposited from a vaporiser containing a charge comprising a mixture of Si and SiO₂, SiO_{y} or a mixture thereof, and the SiOₓ layer being vapour-deposited from a vaporiser charged with silicon.

The process mentioned above makes available gloss pigments A which, compared with natural mica effect pigments and with effect pigments produced in wet procedures, have a high degree of plane parallelism and a defined thickness in the range of ±10%, preferably ±5%, of the average thickness.

The separating agent condensed onto the carrier may be a surface coating, an organic substance soluble in organic solvents or water and vaporisable in vacuo, such as anthracene, anthraquinone, acetamidophenol, acetylsalicylic acid, camphoric anhydride, benzimidazole, benzene-1,2,4-tricarboxylic acid, biphenyl-2,2-dicarboxylic acid, bis(4-hydroxyphenyl)sulfone, dihydroxyanthraquinone, hydantoin, 3-hydroxybenzoic acid, 8-hydroxyquinoline-5-sulfonic acid monohydrate, 4-hydroxycoumarin, 7-hydroxycoumarin, 3-hydroxynaphthalene-2-carboxylic acid, isophthalic acid, 4,4-methylene-bis-3-hydroxynaphthalene-2-carboxylic acid, naphthalene-1,8-dicarboxylic anhydride, phthalimide and its potassium salt, phenolphthalein, phenothiazine, saccharin and its salts, tetraphenylmethane, triphenylene, triphenylmethanol or a mixture of at least two of those substances. The separating agent is preferably an inorganic salt soluble in water and vaporisable in vacuo (see, for example, DE 198 44 357), such as sodium chloride, potassium chloride, lithium chloride, sodium fluoride, potassium fluoride, lithium fluoride, calcium fluoride, sodium aluminium fluoride and disodium tetraborate.

The SiO_{y} layer is obtained by heating a preferably stoichiometric mixture of fine silicon and quartz (SiO₂) powder in a vaporiser described, for example, in DE 43 42 574 C1 and in U.S. Pat. No. 6,202,591 to more than 1300° C. under a high vacuum. The reaction product is silicon monoxide gas, which under vacuum is directed directly onto the passing carrier, where it condenses as SiO. Non-stoichiometric mixtures may also be used. The vaporiser contains a charge comprising a mixture of Si and SiO₂, SiO_{y}, or a mixture thereof, the particle size of the substances that react with one another (Si and SiO₂) being advantageously less than 0.3 mm. The weight ratio of Si to SiO₂ is advantageously in the range from 0.15:1 to 0.75:1 (parts by weight); preferably, a stoichiometric mixture is present. SiOₓ present in the vaporiser vaporises directly. Si and SiO₂ react at a temperature of more than 1300° C. to form silicon monoxide vapour.

According to the invention, step v) is carried out at a pressure that is higher than the pressure in steps i) to iv) and lower than atmospheric pressure.

The (movable) carrier preferably comprises one or more continuous metal belts, with or without a polymer coating, or one or more polyimide or polyethylene terephthalate belts. The (movable) carrier may furthermore comprise one or more discs, cylinders or other rotationally symmetrical bodies, which rotate about an axis.

The gloss pigments are separated from the solvent of the separating agent preferably by washing-out and subsequent filtration, sedimentation, centrifugation, decanting or evaporation. Furthermore, the gloss pigments may, after washing-out of the dissolved separating agent contained in the solvent, be frozen together with the solvent and subsequently subjected to a process of freeze-drying, whereupon the solvent is separated off as a result of sublimation below the triple point and the dry product remains behind in the form of individual plane-parallel structures.

The silicon suboxide condensed on the movable carrier starting from vaporised SiO corresponds to the formula SiO_{y} wherein 0.95≦y≦1.8, preferably wherein 1.1≦y≦1.5, y values of less than 1 being obtained by means of an excess of silicon in the vaporiser material. Except under an ultra-high vacuum, in industrial vacuums of a few 10⁻² Pa vaporised SiO always condenses as SiO_{y} wherein 1≦y≦1.8, especially wherein 1.1≦y≦1.5, because high-vacuum apparatuses always contain, as a result of gas emission from surfaces, traces of water vapour which react with the readily reactive SiO at vaporisation temperature. The SiO_{y} layers can be converted into SiO₂ layers by means of oxidative heat treatment.

If, under industrial vacuums of a few 10⁻² Pa, Si is vaporised instead of SiO, silicon oxides that have a less-than-equimolar oxygen content are obtained, that is to say SiOₓ wherein 0.03≦x≦0.95, especially 0.05≦x≦0.5, most especially 0.1≦x≦0.3, which have astonishingly high stability to oxidation along with a high refractive index, even in thin layers. Heating in the presence of oxygen at from 150 to 500° C., preferably from 175 to 300° C., unexpectedly results in a very thin, for example approximately 20 nm thick, superficial silicon dioxide layer, which is a very convenient method of producing structures having the layer sequence SiO₂/SiOₓ/SiO₂/SiOₓ/SiO₂. If thicker silicon dioxide layers are desired, they may conveniently be produced, as described above, by means of vapour-deposition of SiO_{y} and oxidative heat treatment thereof.

In detail, a salt, for example NaCl, followed by the layers of SiOₓ and SiO_{y} are successively vapour-deposited onto a carrier, which may be a continuous metal belt, passing by way of the vaporisers under a vacuum of <0.5 Pa, the vapour-deposited thicknesses of salt being approximately from 20 to 100 nm, preferably from 30 to 60 nm. On its further course, the belt-form carrier, which is closed to form a loop, runs through dynamic vacuum lock chambers of known construction (cf. U.S. Pat. No. 6,270,840) into a region of from 1 to 5×10⁴ Pa pressure, preferably from 600 to 10⁹ Pa pressure, and especially from 10³ to 5×10³ Pa pressure, where it is immersed in a separating bath. The temperature of the solvent should be so selected that its vapour pressure is in the indicated pressure range. With mechanical assistance, the separating agent layer rapidly dissolves and the product layer breaks up into flakes, which are then in the form of a suspension in the solvent. On its further course, the belt is dried and freed from any contaminants still adhering to it. It runs through a second group of dynamic vacuum lock chambers back into the vaporisation chamber, where the process of coating with separating agent and product layer is repeated.

The suspension then obtained in both cases, comprising product structures and solvent with separating agent dissolved therein, is then separated in a further operation in accordance with a known technique. For that purpose, the product structures are first concentrated in the liquid and rinsed several times with fresh solvent in order to wash out the dissolved separating agent. The product, in the form of a solid that is still wet, is then separated off by means of filtration, sedimentation, centrifugation, decanting or evaporation.

After drying, the product can be subjected to oxidative heat treatment, in which SiO_{y} is converted to SiO₂. Known methods are available for that purpose. Air or some other oxygen-containing gas is passed through the plane-parallel structures, which are in the form of loose material or in a fluidised bed, for several hours at a temperature of more than 200° C., preferably more than 400° C. and especially from 500 to 1000° C. The product can then be brought to the desired particle size by means of grinding or air-sieving and delivered for further use.

It is possible to arrange a plurality of separating agent and product vaporisers one after another in the running direction of the belt in the vaporisation zone. By that means there is obtained, with little additional outlay in terms of apparatus, a layer sequence of S+P+S+P, wherein S is the separating agent layer and P is the product layer. If the number of vaporisers is doubled and the belt speed is the same, twice the amount of product will obtained.

Separating off the plane-parallel structures after washing-out at atmospheric pressure can be carried out under gentle conditions by freezing the suspension, which has been concentrated to a solids content of approximately 50%, and subjecting it in known manner to freeze-drying at approximately −10° C. and 50 Pa pressure. The dry substance remains behind as product, which can be subjected to the steps of further processing by means of coating or chemical conversion.

Instead of using a continuous belt, it is possible to produce the product by carrying out the steps of vapour-deposition of separating agent and SiO, of separation, and of drying the carrier, in an apparatus having a rotary body, in accordance with DE 199 52 032. The rotary body may be one or more discs, a cylinder or any other rotationally symmetrical body.

The process described hereinbefore makes it possible to produce gloss pigments with a high production rate, having very good stability properties and being distinguished by a wide range of possible hues with high colour saturation and covering power.

The gloss pigments produced in accordance with the process described above have, especially, a high degree of colour purity and gloss and are highly shear-stable. The pigment platelets separated from the carrier have, with respect to one another, substantially identical and reproducible optical properties, such as, for example, the same hue when viewed from a particular angle, because the thickness of the colours can be readily controlled.

The optional coating with TiO₂ can result in more intense colours and is preferably applied by precipitation by wet chemical means.

The titanium oxide layers are obtainable, for example, analogously to a method described in DE 195 01 307, by producing the titanium oxide layer by controlled hydrolysis of one or more titanic acid esters, where appropriate in the presence of an organic solvent and a basic catalyst, by means of a sol-gel process. Suitable basic catalysts are, for example, amines, such as triethylamine, ethylenediamine, tributylamine, dimethylethanolamine and methoxy-propylamine. The organic solvent is a water-miscible organic solvent, such as a C₁₋₄alcohol, especially isopropanol.

Suitable titanic acid esters are selected from the group comprising alkyl and aryl alcoholates, carboxylates, and carboxyl-radical- or alkyl-radical- or aryl-radical-substituted alkyl alcoholates or carboxylates of titanium. The use of tetraisopropyl titanate is preferred. In addition, acetylacetonates and acetoacetylacetonates of titanium, such as titanium acetylacetonate, may be used. According to an embodiment of the present invention, the process described in U.S. Pat. No. 3,553,001 is used for application of the titanium dioxide layers.

An aqueous titanium salt solution is slowly added to a suspension of the material being coated, which suspension has been heated to approximately 50-100° C., especially 70-80° C., and a substantially constant pH value of approximately from 0.5 to 5, especially approximately from 1.2 to 2.5, is maintained by simultaneously metering in a base, such as, for example, aqueous ammonia solution or aqueous alkali metal hydroxide solution. As soon as the desired layer thickness of precipitated TiO₂ has been achieved, the addition of titanium salt solution and base is stopped.

That process, also referred to as a titration process, is distinguished by the fact that an excess of titanium salt is avoided. That is achieved by feeding in for hydrolysis, per unit of time, only that amount which is necessary for even coating with the hydrated TiO₂ and which can be taken up per unit of time by the available surface of the particles being coated. In principle, the anatase form of TiO₂ forms on the surface of the starting pigment. By adding small amounts of SnO₂, however, it is possible to force the rutile structure to be formed. For example, as described in WO 93/08237, tin dioxide can be deposited before titanium dioxide precipitation.

Where appropriate, an SiO₂ protective layer can be applied on top of the titanium dioxide layer, for which the following method may be used: A soda waterglass solution is metered in to a suspension of the material being coated, which suspension has been heated to approximately 50-100° C., especially 70-80° C. The pH is maintained at from 4 to 10, preferably from 6.5 to 8.5, by simultaneously adding 10% hydrochloric acid. After addition of the waterglass solution, stirring is carried out for a further 30 minutes.

It is possible to obtain pigments that are more intense in colour and more transparent by applying, on top of the TiO₂ layer, a metal oxide of low refractive index, such as SiO₂, Al₂O₃, AlOOH, B₂O₃ or a mixture thereof, preferably SiO₂, and applying a further TiO₂ layer on top of the latter layer.

It is furthermore possible to subject the finished pigment to subsequent coating or subsequent treatment, which further increases the light, weather and chemical stability or which facilitates handling of the pigment, especially its incorporation into various media. For example, the procedures described in DE 22 15 191, DE 31 51 354, DE 32 35 017 or DE 33 34 598 are suitable as subsequent treatment or subsequent coating.

The core B(a) of gloss pigment B preferably has a thickness of from 20 to 350 nm.

One or more further layers are optionally applied to the parallel faces of the core B(a) of gloss pigment B of SiOₓ.

In one embodiment of the gloss pigment B used according to the invention, there is applied to the core B(a) a layer B(b) having a thickness of from 0 to 500 nm, comprising from 17 to 51 atom % silicon bonded to more than 95 atom % oxygen, based on 100 atom % silicon.

In further embodiments of the gloss pigment B used according to the invention there is applied either directly to the core B(a) or to the layer B(b) of the above-mentioned embodiment a layer B(c) having a thickness of from 0 to 300 nm, that has a transparency of from 50 to 100% and a complex refractive index n+ik satisfying the condition \sqrt{n²+k²}≧1.5 at the wavelength of maximum visible reflection of the particles, and that substantially consists of carbon, an organic compound, a metal, a dielectric or a mixture thereof.

The layers B(b) and/or B(c) are preferably arranged symmetrically about the core B(a), both as regards composition and as regards layer thickness.

In addition to the optionally present layers B(b) and/or B(c), further layers may also be present.

The gloss pigments B used according to the invention preferably comprise particles having at least one layer B(b) and B(c), preferably particles having at least one layer B(b) and especially also those having both a layer B(c) and a layer B(b). Special preference is given, therefore, to particles having the layer sequences B(b)-B(a)-B(b) and B(c)-B(b)-B(a)-B(b)-B(c).

The gloss pigment particles B preferably have lengths and widths of from 5 to 20 μm and thicknesses of from 60 nm to 1.0 μm.

The core B(a) preferably comprises from 60 to 93 atom %, and especially from 65 to 91 atom %, silicon. The silicon in the core B(a) is preferably bonded to from 5 to 50 atom % oxygen and especially to from 10 to 30 atom % oxygen, based on 100 atom % silicon.

The core B(b) preferably has a thickness of from 20 to 250 nm and preferably comprises from 20 to 40 atom % silicon bonded to more than 150 atom % oxygen per 100 atom % silicon, especially from 30 to 36 atom % silicon bonded to more than 178 atom % oxygen per 100 atom % silicon. Most preferably, at least 90 atom % of the layer B(b) consists of SiO₂.

The layer B(c) preferably has a thickness of from 20 to 250 nm and especially from 30 to 100 nm.

The layers B(b) and B(c) need not be present but offer advantages, both on an individual basis and in combination, with regard to colour characteristics and stability. Further layers may optionally be applied to the said layers. The layer B(c) offers useful practical advantages especially when it is applied as the final layer in the vapour-deposition process or is formed immediately after vapour-deposition. Further layers may then be applied using simpler, for example chemical, methods.

It is also possible to produce particles, for example, having the layer sequence B(c)-B(a)-B(c). Useful materials for the layer B(c) are, for example, metals such as Ag, Al, Au, Cu, Co, Cr, Fe, Ge, Mo, Nb, Ni, Si, Ti, V, alloys thereof, inorganic or organic pigments or colorants, graphite and compounds similar to graphite as disclosed in EP 0 982 376, metal oxides such as MoS₂, TiO₂, ZrO₂, SiO, SiO₂, SnO₂, GeO₂, ZnO, Al₂O₃, V₂O₅, Fe₂O₃, Cr₂O₃, PbTiO₃ or CuO, and mixtures thereof. The layer B(c) may, however, also consist of, for example, any one of the many dielectric materials whose resistivity according to the conventional definition is at least 10¹⁰ Ω·cm, which are likewise very well known to the person skilled in the art.

The transparency of the layer B(c) is advantageously at least 50%, corresponding to a reflectivity of at most 50%. With a metal, the skilled person will know how to achieve this by means of appropriately thin layers, for example using up to approximately 3 nm of Al or Au or up to approximately 10 nm of Co or Cu. In the case of colourless or coloured dielectrics greater thicknesses are possible.

Silicon oxides having a less-than-equimolar oxygen content (SiOₓ wherein 0.03≦x≦0.95, especially 0.05≦x≦0.5, more especially 0.1≦x≦0.3) have astonishingly high stability to oxidation along with a high refractive index, even in thin layers. Hydrolysis or heating in the presence of oxygen at from 150 to 500° C., preferably from 200 to 300° C., unexpectedly results in a very thin, for example approximately 20 nm thick, superficial silicon dioxide layer, which is a very convenient method of producing structures having the layer sequence B(b)-B(a)-B(b). If thicker silicon dioxide layers are desired, they can be conveniently produced analogously to the method of the second implementation example of WO 00/43565 by means of vapour-deposition of silicon monoxide and subsequent heat-treatment. It is advantageous therein that the layer of silicon oxide lying underneath the silicon monoxide and having a less-than-equimolar oxygen content remains unchanged.

Further layers may subsequently be applied to structures having the layer sequence B(b)-B(a)-B(b), for example in order to obtain B(c)-B(b)-B(a)-B(b)-B(c), which may be produced especially conveniently by wet-chemical application of a layer B(c) onto structures having the layer sequence B(b)-B(a)-B(b).

The core B(a) is produced, for example, by vapour-deposition onto a medium that can be readily dissolved away subsequently, as disclosed, for example, in DE 19 844 357, EP 0 990 715, U.S. Pat. No. 5,135,812, U.S. Pat. No. 6,270,840, WO 93/08237, WO 00/18978, WO 01/57287 or any of the references cited therein. For vapour-depositing the core B(a) there is advantageously used metallic silicon, which need not be of high purity. It is preferable to use silicon having a content of less than 99.999% by weight Si, for example from 50 to 99.9% by weight Si, especially from 55 to 99% by weight Si, more especially from 60 to 98% by weight Si, very especially from 65 to 90% by weight Si. Impurities may be present, for example elements of the main groups 13, 14 and 15 and/or transition elements, such as Fe, Al, Ge, Sn and/or Sb.

The layers B(b) or B(c) may also be produced, for example, by vapour-deposition, commencing in this case—for symmetrical structures—with vapour-deposition of the layer B(b) or B(c), onto which the core and then a further layer B(b) or B(c) are vapour-deposited.

The vapour-deposition and isolation of the vapour-deposited layers are advantageously carried out in accordance with the process described above for gloss pigments A.

Gloss pigments A and B are described in U.S. Pat. No. 5,766,335, Swiss Patent Application No. 1334/02 and European Patent Applications No. EP 02 405 749.9 and No. EP 03 405 024.5. Gloss pigments A and B can be used in the process according to the invention on their own or in admixture. It is also possible to use mixtures of gloss pigments A and/or B with other effect pigments.

The gloss pigments used according to the invention are goniochromatic and result in brilliant, highly saturated (lustrous) colours. They are therefore very especially suitable for combination with conventional, transparent pigments, for example organic pigments, such as, for example, diketopyrrolopyrroles, quinacridones, dioxazines, perylenes, isoindolinones etc. The transparent pigment may have a similar colour to the effect pigment. Especially interesting combination effects are obtained, however, analogously to EP 0 388 932 or EP 0 402 943 for example, when the colour of the transparent pigment and that of the effect pigment are complementary.

The process according to the invention is carried out in accordance with known textile dyeing and printing processes using conventional pigments as described, for example, in Textile Chemist and Colorist 25 (1993) 31-37.

The gloss pigments and the conventional pigments optionally combined therewith are advantageously used in the dyeing preparations, for example dye baths or printing pastes, in dispersed form.

During dispersion of the effect pigments used according to the invention and during processing thereof, conditions under which only relatively weak shearing forces occur are preferably maintained so that the effect pigment will not be broken up into smaller fragments. The permissible shear force approximately corresponds to that which is permissible for the core, the gentle dispersion of which in a high-molecular-weight organic material is generally well-known to the person skilled in the art.

The customary dispersants, preferably non-ionic dispersants, can be used for the preparation of the dispersions.

Suitable binders for the process according to the invention include the pigment dyestuff binders customarily employed in textile dyeing and textile printing, for example acrylate-based, urethane-based or butadiene-based binders. Such binders are known to the person skilled in the art.

Suitable acrylate binders are, for example, acrylic polymers, such as, for example, poly(meth)acrylates, or mixed polymers of (meth)acrylates with suitable comonomers, such as, for example, acrylic, methacrylic, maleic, fumaric, itaconic, mesaconic, citraconic, vinyl-acetic, vinyloxyacetic, vinylpropionic, crotonic, aconitic, allylacetic, allyloxyacetic, allyl-malonic, 2-acrylamido-2-methylpropanesufonic, glutaconic or allylsuccinic acid, or with esters of those acids, (meth)acrylamide, N-vinylpyrrolidone, N-vinylformamide, N-vinylacetamide, (meth)acrolein, N-vinyl-N-methylacetamide, vinylcaprolactam, styrene derivatives or vinyl-phosphonic acid; polyamide derivatives; synthetic resin dispersions; vinyl-based mixed polymers; diamide/aldehyde precondensates; mixed polymers comprising N-vinyllactam or butadiene-based polymers. Suitable acrylate binders are soluble in aqueous medium or in aqueous medium containing water-miscible organic solvents, where applicable with the addition of bases. The said acrylate binders are preferably used in the form of an aqueous formulation. Such acrylate binders are commercially available in acidic form or in partially or completely neutralised form, for example Primal® (Rohm & Haas), Neocryl® (NeoResins), Carbocet® (BF Goodrich), Joncryl® (Johnson Polymers) or ALCOPRINT® (Ciba Specialty Chemicals) binders.

According to an embodiment of the present invention, the dyeing preparation, for example the printing paste or the dye bath, is prepared by using a concentrated formulation comprising the gloss pigment and the binder. Such formulations will preferably be aqueous formulations. The weight ratio between gloss pigment and binder is preferably from 1:1 to 1:50, especially from 1:1 to 1:10. A weight ratio of from 1:1 to 1:5 is especially preferred. The gloss pigment is present in the formulation preferably in an amount of from 2 to 80 g/kg, especially in an amount of from 5 to 50 g/kg. The binder is present in the formulation preferably in an amount of from 20 to 200 g/kg, especially in an amount of from 30 to 150 g/kg.

The dyeing preparations may additionally comprise further auxiliaries customarily used, for example, in pigment printing, for example crosslinkers.

Suitable crosslinkers are, for example, water-soluble melamine, formaldehyde/melamine and formaldehyde/urea resins or precondensates, such as trimethylolmelamine, hexamethylol-melamine or dimethylol urea, or water-soluble formaldehyde (pre)condensation products with formamide, thiourea, guanidine, cyanamide, dicyandiamide and/or water-soluble organic sulfonates, such as, for example, the sodium salt of naphthalenesulfonic acid, or glyoxalic urea derivatives, such as, for example, the compound of formula 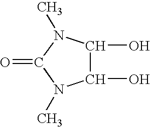
and especially N-methylol derivatives of nitrogen-containing compounds, such as, for example, non-etherified or etherified melamine/formaldehyde condensation products or N-methylol urea compounds.

Examples of non-etherified or etherified melamine/formaldehyde condensation products are the compounds of formulae

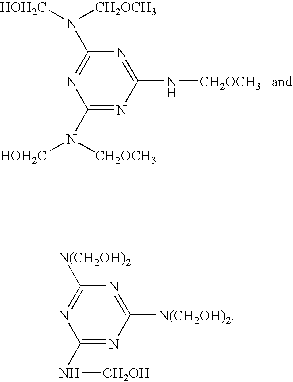

The non-etherified or etherified N-methylol urea compounds are, for example, reaction products of formaldehyde with urea or urea derivatives, which reaction products may have been subsequently etherified, suitable urea derivatives being, for example, cyclic ethylene or propylene ureas that may also contain substituents such as hydroxyl groups in the alkylene group, urones or unsubstituted or substituted triazone resins.

Examples of corresponding N-methylol urea compounds are unmodified or modified N-methylolhydroxyethylene urea products, for example the compounds of formula 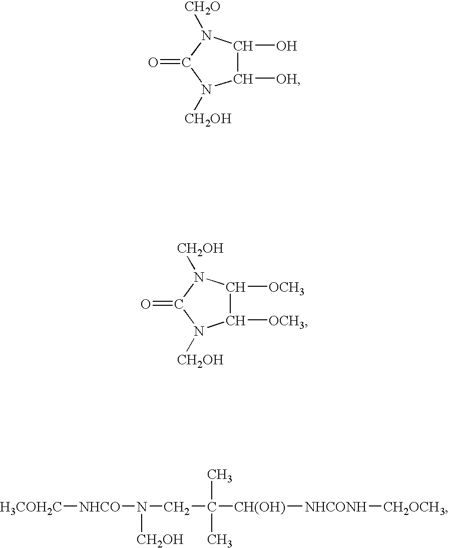
or methylolation products based on propylene urea or ethylene urea/melamine.

Preferred crosslinkers are unmodified or modified N-methylolhydroxyethylene urea compounds, methylolation products based on propylene urea or ethylene urea/melamine and, especially, non-etherified or etherified melamine/formaldehyde condensation products. It is also possible to use mixtures of two or more different water-soluble crosslinkers, for example a mixture consisting of a non-etherified and an only partially etherified melamine/formaldehyde condensation product.

Suitable crosslinkers are known commercially, for example under the name ALCOPRINT® (Ciba Specialty Chemicals).

If desired, crosslinking catalysts may additionally be used.

Suitable crosslinking catalysts for the process according to the invention are, for example, any agents customarily used as catalysts for non-crease and non-crumple finishes, as are known from Textilhilfsmittelkatalog 1991, Konradin Verlag R. Kohlhammer, Leinfelden-Echterdingen 1991. Examples of suitable crosslinking catalysts are inorganic acids, for example phosphoric acid; Lewis acids, for example zinc chloride, zirconium oxychloride, NaBF₄, AlCl₃, MgCl₂; ammonium salts, for example ammonium sulfate, ammonium chloride; or hydrohalides, especially hydrochlorides of organic amines, for example CH₃—CH₂—CH₂—NH—CH₃. HCl. Preference is given to the use of ammonium salts or magnesium-containing Lewis acids and, especially, to the use of ammonium chloride or magnesium chloride.

To increase the softness of the dyed or printed fibre material and thus to obtain a particular handle, the dyeing preparations used according to the invention may additionally comprise a fabric softener. Fabric softeners are known in the textile industry. They are non-ionic, anionic-active, cationic or amphoteric softeners. Emulsions of silicones, mostly high-molecular-weight α,ω-dimethylpolysiloxane, occupy a special position. Fabric softeners based on silicone emulsions are preferred. Such fabric softeners are commercially available, for example under the name AVIVAN® or ULTRATEX® (Ciba Specialty Chemicals).

If desired, the dyeing preparation may additionally comprise acid donors such as butyro-lactone or sodium hydrogen phosphate, preservatives, sequestering agents, emulsifiers, water-insoluble solvents, oxidising agents or deaerating agents.

Suitable preservatives are especially formaldehyde-yielding agents, such as, for example, paraformaldehyde and trioxane, especially aqueous, approximately from 30 to 40% by weight formaldehyde solutions; suitable sequestering agents are, for example, nitrolotriacetic acid sodium, ethylenediaminetraacetic acid sodium, especially sodium polymetaphosphate, more especially sodium hexametaphosphate; suitable emulsifiers are especially adducts of an alkylene oxide and a fatty alcohol, especially an adduct of oleyl alcohol and ethylene oxide; suitable water-insoluble solvents are high boiling, saturated hydrocarbons, especially paraffins having a boiling range of approximately from 160 to 210° C. (so-called white spirit); a suitable oxidising agent is, for example, an aromatic nitro compound, especially an aromatic mono- or di-nitro-carboxylic or -sulfonic acid which may be in the form of an alkylene oxide adduct, especially a nitrobenzenesulfonic acid; and suitable deaerating agents are, for example, high boiling solvents, especially turpentine oils, higher alcohols, preferably C₈-C₁₀alcohols, terpene alcohols or deaerating agents based on mineral oils and/or silicone oils, especially commercial formulations composed of approximately from 15 to 25% by weight of a mineral oil and silicone oil mixture and approximately from 75 to 85% by weight of a C₈ alcohol, such as, for example, 2-ethyl-n-hexanol.

The dyeing preparations can be applied to the fibre materials by various methods, especially in the form of aqueous dye baths and printing pastes. They are especially suitable for dyeing by the pad dyeing process and for printing. Printing is preferred.

Other suitable processes are the foam dyeing process, the spray dyeing process and printing by the ink-jet printing process or by the chromojet process which is used, for example, in carpet printing.

The amounts in which the gloss pigments are used in the dyeing baths or printing pastes may vary depending upon the desired depth of colour; in general, amounts of from 0.01 to 15% by weight, especially from 0.1 to 10% by weight, based on the weight of the material being dyed, and from 0.05 to 200 g, especially from 1.0 to 100 g, of gloss pigments per kg of printing paste have proved advantageous.

According to a preferred embodiment of the present invention, the dyeing preparation is made by first preparing a formulation comprising all the components with the exception of the gloss pigment. The gloss pigment is then incorporated into the formulation in the required quantity. The ratios by weight and the quantity information given above apply in this case.

Preferably, the dyeing preparations according to the invention are used in the form of a printing paste.

The printing paste usually comprises from 1 to 400 g, especially from 20 to 250 g, of binder per kg of printing paste.

In addition to comprising gloss pigment and binder, the printing paste advantageously comprises thickeners of synthetic origin, such as, for example, those based on poly(meth)acrylic acids, poly(meth)acrylamides, and their copolymers and terpolymers.

Thickeners based on potassium or sodium salts of poly(meth)acrylic acids are preferably used since the addition of ammonia or ammonium salts can advantageously be partially or completely dispensed with when such thickeners are used.

Examples of other thickeners are commercial alginate thickenings, starch ethers, locust bean flour ethers and cellulose ethers. Suitable cellulose ethers are, for example, methyl-, ethyl-, carboxymethyl-, hydroxyethyl-, methylhydroxyethyl-, hydroxypropyl- and hydroxypropyl-methyl-cellulose. Suitable alginates are especially alkali metal alginates and preferably sodium alginate.

In printing of the fibre material, the printing paste is applied directly to the fibre material over the entire surface or in places, advantageously using printing machines of conventional design, for example intaglio printing machines, rotary screen printing machines, roller printing machines and flat screen printing machines.

In one interesting embodiment of the process according to the invention, the textile fibre material is printed by the transfer printing or thermoprinting process. In that process, first a carrier material, for example a web of paper, is printed and then, in a further step, the print is transferred from the carrier material to the textile fibre material. Transfer printing or thermoprinting processes are known to the person skilled in the art, for example from N. L. Moore, J. Soc. Dyers and Colourists, 09/1974, pages 318 to 325.

After being printed, the fibre material is advantageously dried, preferably at temperatures of from 80 to 120° C.

Fixing of the print can then be carried out, for example, by a heat treatment, which is preferably performed at a temperature of from 120 to 190° C. Fixing preferably takes from 1 to 8 minutes in that case.

Fixing can also be carried out, however, with ionising radiation or by irradiation with UV light.

When ultraviolet radiation is used, the presence of a photoinitiator is generally required. The photoinitiator absorbs the radiation in order to produce free radicals that initiate the polymerisation. Suitable photoinitiators are known to the person skilled in the art.

Following fixing, the dyed or printed fibre material may, if desired, be washed and dried in the usual manner.

The process according to the invention is suitable for dyeing or printing very diverse fibre materials, such as wool, silk, cellulose, polyacrylonitrile, polyamide, aramide, polyolefins, for example polyethylene or polypropylene, polyesters or polyurethane.

Preference is given to fibre materials containing cellulose. Suitable fibre materials containing cellulose are materials that consist entirely or partially of cellulose. Examples are natural fibre materials, such as cotton, linen or hemp, regenerated fibre materials, such as, for example, viscose, polynosic or cuprammonium rayon. Also suitable are mixed fibre materials containing cellulose, that is to say, mixtures of cellulose and other fibres, especially cotton/polyester fibre materials.

Wovens, knits or webs of those fibres are mainly used.

Using the process according to the invention it is possible to obtain textiles whose colour changes in dependence upon the viewing angle (“flop effect”). In particular, the gloss pigments not having the TiO₂ coating, which consist only of silicon and oxygen, are, by virtue of the fact that they are free of heavy metals, outstandingly suitable for textile applications.

The colorations and prints obtainable by the process according to the invention are especially distinguished by an extremely high saturation and high goniochromaticity. They also have good general fastness properties, such as, for example, good light fastness, good fastness to wetting, such as fastness to washing, water, sea water, cross-dyeing and perspiration, good fastness to chlorine, fastness to rubbing, fastness to ironing and fastness to pleating.

The following Examples serve to illustrate the invention without limiting the scope thereof. Unless stated otherwise, temperatures are given in degrees Celsius, parts therein are parts by weight and percentages are percentages by weight. The relationship between parts by weight and parts by volume is the same as that between kilograms and litres.

### PREPARATION EXAMPLES 1A TO 1E (GLOSS PIGMENTS A)

A layer of approximately 50 nm of NaCl is vapour-deposited onto a metallic carrier in a vacuum chamber at a pressure of less than approximately 10⁻² Pa. Then, at the same pressure, the following materials are successively vapour-deposited: Si, SiO and Si, whereby a film having the layer structure SiOₓ/SiO_{y}/SiOₓ is produced on the metal belt. The separating agent is then dissolved in water, whereupon flakes come away from the substrate. At atmospheric pressure, the resulting suspension is concentrated by filtration and rinsed several times with deionised water in order to remove Na⁺ and Cl⁻ ions that are present. That is followed by the steps of drying and, where applicable, heating of the plane-parallel SiOₓ structures in the form of loose material at 200° C. for two hours in an oven through which air heated to 200° C. is passed. On heating of the platelets, an SiO₂ layer approximately 20 nm thick is formed on the surface, on the SiOₓ layer. After cooling, comminution and grading by air-sieving are carried out.

In accordance with the process described above, the products listed in the following Table 1 are obtained:

TABLE 1

| | SiO_{0.2} | SiO₂ | SiO_{0.2} | | |
|---|---|---|---|---|---|
| Example | [nm] | [nm] | [nm] | Colour | Colour change |
| 1a | 45 | 160 | 45 | matt orange | matt orange to matt |
| | | | | | yellow-green |
| 1b | 45 | 240 | 45 | matt blue- | matt blue-green to |
| | | | | green | matt violet |
| 1c | 45 | 260 | 45 | glossy blue- | glossy blue-green |
| | | | | green | to glossy violet |
| 1d | 45 | 280 | 45 | glossy green | glossy green to |
| | | | | | violet |
| 1e | 45 | 440 | 45 | glossy | glossy yellow-green |
| | | | | yellow-green | to glossy green |

The pigments obtained in accordance with Preparation Example 1 exhibit a colour change when the viewing angle is changed.

### PREPARATION EXAMPLES 2A TO 2K (GLOSS PIGMENTS B)

2a) A graphite crucible containing silicon granules (purity: 95% by weight Si) and one containing sodium chloride are placed as materials to be vapour-deposited in a vacuum vapour-deposition chamber having a rotating aluminium drum as the target. At a pressure of approximately 0.1 Pa, first 100 nm of sodium chloride are vapour-deposited and then, in the course of 100 seconds, 100 nm of silicon in the form of a low-oxide compound (by reaction with some of the oxygen that is present). The coated aluminium drum is immersed in water; the product, which breaks up into particles, is recovered by filtration, rinsed with water and dried in air at 150° C. A brilliant green power having a goniochromatic effect is obtained.

2b) The procedure is analogous to Example 2a, but 120 nm of silicon in the form of a low-oxide compound are vapour-deposited. A brilliant orange-red powder having a goniochromatic effect is obtained.

2c) The procedure is analogous to Example 2a, but 125 nm of silicon in the form of a low-oxide compound are vapour-deposited. A brilliant red powder having a goniochromatic effect is obtained.

2d) The procedure is analogous to Example 2a, but 130 nm of silicon in the form of a low-oxide compound are vapour-deposited. A brilliant purple powder having a goniochromatic effect is obtained.

2e) The procedure is analogous to Example 2a, but first 100 nm of sodium chloride are vapour-deposited and then 25 nm of silicon monoxide, 90 nm of silicon in the form of a low-oxide compound and again 25 nm of silicon monoxide. Heating is subsequently carried out in air at 250° C. for 1 hour, the outer layer being converted into silicon dioxide and at the same time increasing in thickness. A brilliant purple powder having a strong goniochromatic effect is obtained.

2f) The procedure is analogous to Example 2e, but first 100 nm of sodium chloride are vapour-deposited and then 50 nm of TiO₂, 25 nm of silicon dioxide, 50 nm of silicon in the form of a low-oxide compound, 25 nm of silicon dioxide and 50 nm of TiO₂. A violet powder having a strong goniochromatic effect is obtained.

2g) The procedure is analogous to Example 2e, but first 100 nm of sodium chloride are vapour-deposited and then 50 nm of TiO₂, 50 nm of silicon dioxide, 50 nm of silicon in the form of a low-oxide compound, 50 nm of silicon dioxide and 50 nm of TiO₂. A blue powder having a strong goniochromatic effect is obtained.

2h) The procedure is analogous to Example 2e, but first 100 nm of sodium chloride are vapour-deposited and then 50 nm of TiO₂, 100 nm of silicon dioxide, 50 nm of silicon in the form of a low-oxide compound, 100 nm of silicon dioxide and 50 nm of TiO₂. A yellow-green powder having high colour saturation and a strong goniochromatic effect is obtained.

2i) The procedure is analogous to Example 2e, but first 100 nm of sodium chloride are vapour-deposited and then 100 nm of TiO₂, 100 nm of silicon dioxide, 100 nm of silicon in the form of a low-oxide compound, 100 nm of silicon dioxide and 100 nm of TiO₂. A red-violet powder having a strong goniochromatic effect is obtained.

2j) The procedure is analogous to Example 2e, but first 100 nm of sodium chloride are vapour-deposited and then 100 nm of TiO₂, 50 nm of silicon dioxide, 100 nm of silicon in the form of a low-oxide compound, 50 nm of silicon dioxide and 100 nm of TiO₂. An orange powder having a strong goniochromatic effect is obtained.

2k) The procedure is analogous to Example 2e, but first 100 nm of sodium chloride are vapour-deposited and then 100 nm of TiO₂, 25 nm of silicon dioxide, 100 nm of silicon in the form of a low-oxide compound, 25 nm of silicon dioxide and 100 nm of TiO₂. A yellow powder having a strong goniochromatic effect is obtained.

### Example 1

A stock thickening is prepared by mixing the following components:

| | |
|---|---|
| 600 | parts water |
| 5 | parts deaerating agent (Lyoprint ® AP)* |
| 5 | parts ammonia (25% ig) |
| 100 | parts acrylate-based binder (Alcoprint ® PB-HC)* |
| 14 | parts thickener (Alcoprint ® PTP)* |

*products of Ciba Specialty Chemicals

The thickener is homogenised in the mixture by means of a high-speed stirrer.

The viscosity of the above-mentioned stock thickening is approximately 14,000 mPas±10% (Brookfield RVT, 25° C., 20 rev/min, spindle 5).

A printing paste is produced by incorporating 0.8 part of the gloss pigment from Preparation Example 1a into 99.2 parts of the above stock thickening.

A cotton fabric is printed with the printing paste on a Zimmer flat screen printing machine (screen 64, squeegee 12 mm, p=6, v=3). The print is dried at 120° C. for 2 minutes and then fixed at 150° C. for 5 minutes. A print having a strong goniochromatic effect from matt orange to matt yellow-green and good fastness to wetting and light is obtained.

### Examples 2 to 5

The procedure is the same as in Example 1, except that, instead of the quantity of gloss pigment A given therein, an identical quantity of one of the gloss pigments A given in the following Table 2 is used, likewise producing prints having a strong goniochromatic effect and good fastness to wetting and light.

TABLE 2

| Ex. | Gloss pigment A from Ex. | Colour |
|---|---|---|
| 2 | 1b | matt blue-green to matt violet |
| 3 | 1c | glossy blue-green to glossy violet |
| 4 | 1d | glossy green to violet |
| 5 | 1e | glossy yellow-green to glossy green |

### Examples 6 to 16

The procedure is the same as in Example 1, except that, instead of the quantity of gloss pigment A given therein, an identical quantity of one of the gloss pigments B from Preparation Examples 2a, 2b, 2c, 2d, 2e, 2f, 2g, 2h, 2i, 2j and 2k is used, likewise producing prints having a strong goniochromatic effect and good fastness to wetting and light.

### Example 17

A stock solution is prepared by mixing the following components:

| | |
|---|---|
| 676 | parts water |
| 10 | parts defoamer (DF-66 25%) |
| 5 | parts dispersant (Albegal ® A)* |
| 10 | parts thickener (Irgapadol ® MP)* |
| 100 | parts binder (Irgaphor ® SPD-B)* |
| 9 | parts fabric softener (Avivan ® MS)* |

*products of Ciba Specialty Chemicals

A cotton fabric is padded with a dyeing composition comprising 80 parts of the stock solution mentioned above, 0.8 part of the gloss pigment from Preparation Example 1a and 19.2 parts water. The impregnated fabric is dried and fixed at from 140 to 170° C. for from 2 to 5 minutes. Alternatively, drying and fixing can also be carried out at 185° C. for 1 minute. A coloration having a strong goniochromatic effect from matt orange to matt yellow-green and good fastness to wetting and light is obtained.

### Examples 18 to 32

The procedure is the same as in Example 17, except that, instead of the quantity of gloss pigment from Preparation Example 1a given therein, an identical quantity of one of the gloss pigments from Preparation Examples 1b, 1c, 1d, 1e, 2a, 2b, 2c, 2d, 2e, 2f, 2g, 2h, 2i, 2j and 2k is used, likewise producing colorations having a strong goniochromatic effect and good fastness to wetting and light.

### Example 33

A stock solution is prepared by mixing the following components:

| | |
|---|---|
| 643 | parts water |
| 10 | parts defoamer (DF-66 25%) |
| 25 | parts thickener (Irgapadol ® MP)* |
| 60 | parts fabric softener (Avivan ® MS)* |
| 2 | parts wetting agent (Cibaflow ® PAD)* |
| 20 | parts binder (Cibatex ® EM)* |
| 40 | parts binder (Dicrylan ® AM)* |

*products of Ciba Specialty Chemicals

A cotton fabric is padded with a dyeing composition comprising 80 parts of the stock solution mentioned above, 0.8 part of the gloss pigment from Preparation Example 1a and 19.2 parts water. The impregnated fabric is dried and fixed at from 140 to 170° C. for from 2 to 5 minutes. Alternatively, drying and fixing can also be carried out at 185° C. for 1 minute. A coloration having a strong goniochromatic effect from matt orange to matt yellow-green and good fastness to wetting and light is obtained.

### Examples 34 to 48

The procedure is the same as in Example 33, except that, instead of the quantity of gloss pigment from Preparation Example 1a, an identical quantity of one of the gloss pigments from Preparation Examples 1b, 1c, 1d, 1e, 2a, 2b, 2c, 2d, 2e, 2f, 2g, 2h, 2i, 2j and 2k is used, likewise producing colorations having a strong goniochromatic effect and good fastness to wetting and light.

1. A process for dyeing or printing textile fibre materials, wherein a gloss pigment A or B is used comprising
A(a) a core consisting of a substantially transparent or metallically reflecting material and
A(b) at least one coating substantially consisting of one or more silicon oxides wherein the molar ratio of oxygen to silicon is on average from 0.03 to 0.95, or
B(a) a core substantially consisting of one or more silicon oxides wherein the molar ratio of oxygen to silicon is on average from 0.03 to 0.95.

2. A process according to claim 1, wherein the core A(a) of gloss pigment A consists of mica, SiO_{y} wherein y is from 0.95 to 1.8, SiO₂ or an SiO₂/TiO₂ mixture.

3. A process according to claim 1, wherein the core A(a) of gloss pigment A is selected from Ag, Al, Au, Cu, Cr, Ge, Mo, Ni, Si, Ti, Zn, alloys thereof, graphite, Fe₂O₃ and MoS₂.

4. A process according to claim 1, wherein the gloss pigment A has the following layer structure: SiO₂/SiOₓ/SiO_{y}/SiOₓ/SiO₂, SiO₂/SiOₓ/SiO₂/SiOₓ/SiO₂, SiO₂/SiOₓ/Al/SiOₓ/SiO₂, TiO₂/SiO₂/SiOₓ/SiO₂/SiOₓ/SiO₂/TiO₂ or TiO₂/SiO₂/SiOₓ/Al/SiOₓ/SiO₂/TiO₂, wherein x is from 0.03 to 0.95 and y is from 0.95 to 1.8.

5. A process according to claim 4, wherein the gloss pigment A has the following layer structure: SiO₂/SiOₓ/SiO_{y}/SiOₓ/SiO₂, SiO₂/SiOₓ/SiO₂/SiOₓ/SiO₂ or TiO₂/SiO₂/SiOₓ/SiO₂/SiOₓ/SiO₂/TiO₂, wherein x is from 0.03 to 0.95 and y is from 0.95 to 1.8, the core is a platelet having an average diameter of from 1 to 50 μm and a thickness of from 20 to 500 nm, the thickness of the SiOₓ layer is from 5 to 200 nm, the thickness of the SiO_{y} or SiO₂ layer is from 1 to 200 nm, and the thickness of the TiO₂ layer is from 1 to 180 nm.

6. A process according to claim 1, wherein the core B(a) of gloss pigment B has a thickness of from 20 to 350 nm.

7. A process according to claim 1, wherein there is applied to the core B(a) of gloss pigment B a layer B(b) having a thickness of from 0 to 500 nm, comprising from 17 to 51 atom % silicon bonded to more than 95 atom % oxygen, based on 100 atom % silicon.

8. A process according to claim 1, wherein there is applied to the core B(a) of gloss pigment B a layer B(c) having a thickness of from 0 to 300 nm, that has a transparency of from 50 to 100% and a complex refractive index n+ik satisfying the condition \sqrt{n²+k²}≧1.5 at the wavelength of maximum visible reflection of the particles, and that substantially consists of carbon, an organic compound, a metal, a dielectric or a mixture thereof.

9. A process according to claim 7, wherein there is applied to the layer B(b) of gloss pigment B a layer B(c) having a thickness of from 0 to 300 nm, that has a transparency of from 50 to 100% and a complex refractive index n+ik satisfying the condition \sqrt{n²+k²}≧1.5 at the wavelength of maximum visible reflection of the particles, and that substantially consists of carbon, an organic compound, a metal, a dielectric or a mixture thereof.

10. A process according to claim 1, wherein the textile fibre material is printed.

11. A process according to claim 1, wherein the textile fibre material is printed by the transfer printing or thermoprinting process.

12. A process according to claim 1, wherein the core A(a) of gloss pigment A is Al.

13. A process according to claim 7, wherein the core B(a) of gloss pigment B has a thickness of from 20 to 350 nm.

14. A process according to claim 8, wherein the core B(a) of gloss pigment B has a thickness of from 20 to 350 nm.

15. A process according to claim 9, wherein the core B(a) of gloss pigment B has a thickness of from 20 to 350 nm.

16. A process according to claim 2, wherein the textile fibre material is printed.

17. A process according to claim 9, wherein the textile fibre material is printed.

18. A process according to claim 13, wherein the textile fibre material is printed.

19. A process according to claim 4, wherein the textile fibre material is printed by the transfer printing or thermoprinting process.

20. A process according to claim 13, wherein the textile fibre material is printed by the transfer printing or thermoprinting process.
